(19) United States
(12) Patent Application Publication
(10) Pub. No.: US 2008/0129509 A1
(43) Pub. Date: Jun. 5, 2008

(54) RFID interrogations of system components in RFID systems

(75) Inventor: Mark Duron, East Patchogue, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/606,094

(22) Filed: Nov. 30, 2006

(51) Int. Cl. G08B 13/14; G06K 7/00

(52) U.S. Cl. 340/572.4; 340/572.8; 340/572.1; 340/572.7; 340/10.1

(57) ABSTRACT

Methods, systems, and apparatuses for an entity in a full duplex radio frequency (RF) communication system are presented. In an aspect, the communication entity includes an antenna assembly and a radio frequency identification (RFID) tag. The antenna assembly includes at least an antenna and an encapsulating body which encapsulates the antenna. The RFID tag is associated with the antenna assembly.

### BACKGROUND OF THE INVENTION

1. Field of the Invention

The present invention relates to wireless communications, and more particularly, to communication entities within a full duplex radio frequency communication system.

2. Background Art

Typical communication systems allow for either half or full duplex communication. In a half duplex system, communication can only be sent in one direction at time. Full duplex systems, conversely, allow for communication in both directions at the same time. An example of a full duplex communication system is a radio frequency identification system (RFID) system. In an RFID system, communication takes places between a population of RFID tags and at least one reader.

RFID tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed as “reader interrogator” or simply “interrogator”.

In an RFID system, an interrogator radiates a carrier wave. Typically this carrier wave has no modulation associated with it, and therefore has no information content. This carrier wave is then received, modulated and reflected by the tag in a process known as backscattering. The backscattered wave may be modulated to include data, such as an identification code specific to the tag. The backscattered wave is then received by the interrogator. Thus information in such a system is only sent in one direction at a time, but since the carrier wave is sent to the tag, the system is still considered a full-duplex system.

With the maturation of RFID technology, efficient communications between tags and interrogators has become a key enabler in supply chain management, especially in manufacturing, shipping, and retail industries, as well as in building security installations, healthcare facilities, libraries, airports, warehouses etc.

In an RFID system, typically a reader transmits a continuous wave (CW) or modulated radio frequency (RF) signal to a tag. The tag receives the signal, and responds by modulating the signal, “backscattering” an information signal to the reader. The reader receives signals back from the tag, and the signals are demodulated, decoded and further processed.

Antennas used by communication entities, such as RFID readers, are sometimes removed and replaced with other antennas. System parameters are often based on the antenna that was originally attached to the entity. Without identifying the new antenna to the system, system parameters cannot be adjusted to reflect the properties of the new antenna. What is needed are inexpensive and non-complex ways of identifying the antennas being used by entities.

### BRIEF SUMMARY OF THE INVENTION

Methods, systems, and apparatuses for an entity in a full duplex radio frequency (RF) system are described. In embodiments, RFID tags are associated with antennas of entities, to be used to identify the antennas.

In an aspect of the present invention, an entity includes an antenna assembly and a radio frequency identification (RFID) tag. The antenna assembly includes at least one antenna and an enclosure or encapsulating body that encapsulates the antenna. In an alternative aspect, the antenna assembly does not include the enclosure or encapsulating body. The RFID tag is associated with the antenna assembly. The RFID tag stores information that can be used to uniquely identify the antenna.

In an aspect, the RFID tag is attached to a surface of the enclosure or encapsulating body.

In another aspect, the RFID tag is attached to a surface of the antenna.

In another aspect, the RFID tag is embedded within the antenna.

In a further aspect, the RFID tag identifies at least one property of the antenna.

In a further aspect, the RFID tag identifies at least one property of a cable attached to the antenna such as length, type, or attenuation factor.

In aspects, communication between the entity and the tag operates under a communication protocol different than communication between the antenna and a second tag in a communication range of the entity. The second tag is not associated with an antenna.

In aspects, the embedded RFID tag is configured to be less sensitive to an RF signal transmitted by the antenna of the entity compared to a second RFID tag in a communication range of the entity that is not associated with the antenna assembly.

In another aspect, the power level or other characteristic of a signal transmitted by the antenna is adjusted to meet a desired level. For example, by identifying the antenna using the RFID tag, a communication system using the antenna can adjust attributes of a signal provided to the antenna to optimize characteristics of the resulting transmitted signal.

In one aspect, the system is an RFID system. In an alternative aspect, the system is a code division multiple access (CDMA) system.

In another aspect, a method of determining a performance of an entity in a full duplex RF system is provided. A coupling factor between an antenna of the RFID tag and the antenna of the entity at a first instance is determined. The coupling factor between the antenna of the tag and the antenna of the entity is determined at a second instance. The coupling factor determined at the first instance is compared to the coupling factor determined at the second instance.

In an alternative aspect, a return level of a signal transmitted from an antenna of the entity and reflected from an RFID tag is measured at a first instance. The antenna is located within an antenna assembly and the RFID tag is attached to a surface of the antenna assembly. The return level of the signal transmitted by the antenna and reflected by the RFID tag is measured at a second instance. The return levels measured at the first and second instances are compared.

In another aspect, a communication entity includes a communication medium, such as a coaxial cable or transmission line, and an RFID tag. The RFID tag is associated with the communication medium. The tag stores information that can be used to identify the communication medium. Furthermore, the tag can be used to monitor performance of the communication medium.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of receiver and transmitter portions of a typical communication entity in a radio frequency (RF) full duplex communication system.

FIGS. 3A and 3B show views of a conventional antenna assembly.

FIGS. 4A-4C shows side cross-sectional views of antenna assemblies, according to example embodiments of the present invention.

FIG. 5A shows an RFID communication system, according to an embodiment of the present invention.

FIG. 5B shows an RFID system after an antenna assembly has been replaced.

FIG. 6 shows a CDMA communication system, according to an embodiment of the present invention.

FIG. 7 shows a flowchart providing an example step for assembly of an antenna assembly, according to an embodiment of the present invention.

FIG. 8 shows additional optional steps of FIG. 7, according to an embodiment of the present invention.

FIG. 9 shows a flowchart providing example steps for measuring a performance of a communication entity, according to an embodiment of the present invention.

FIG. 10 shows a flowchart providing example steps for measuring a performance of a communication entity, according to an embodiment of the present invention.

FIG. 11 shows an example of a full duplex communication system, according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### Example RFID System Embodiment

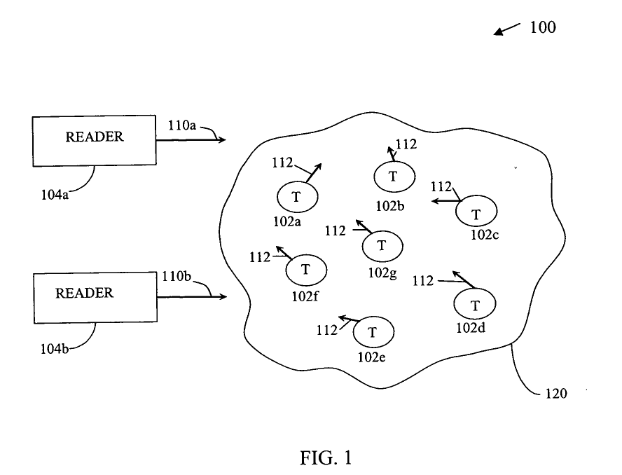

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1, reader 104a transmits an interrogation signal 110 having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

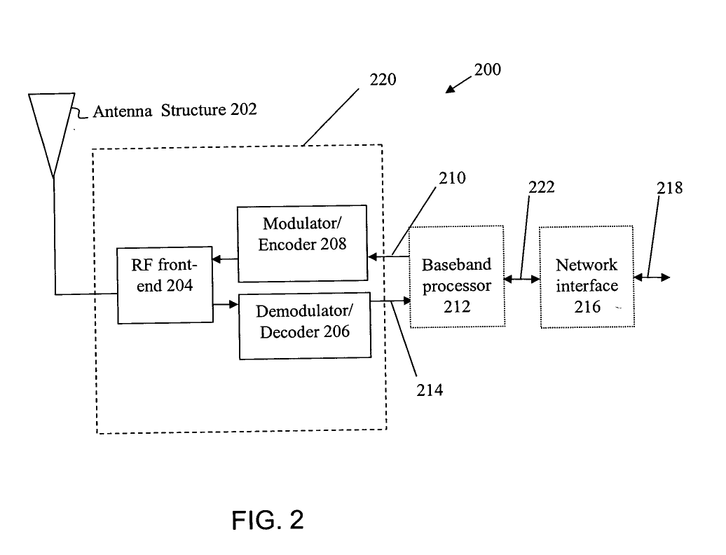

FIG. 2 shows a block diagram of an example communication entity 200. Entity 200 includes antenna assembly 202, a receiver and transmitter portion 220 (also referred to as transceiver 220), and a baseband processor 212, and a network interface 216. These components of entity 200 may include software, hardware, and/or firmware, or any combination thereof, for performing their functions.

Baseband processor 212 and network interface 216 are optionally present in entity 200. Baseband processor 212 may be present in entity 200, or may be located remote from entity 200. For example, in an embodiment, network interface 216 may be present in entity 200, to communicate between transceiver portion 220 and a remote server that includes baseband processor 212. When baseband processor 212 is present in entity 200, network interface 216 may be optionally present to communicate between baseband processor 212 and a remote server. In another embodiment, network interface 216 is not present in entity 200.

In an embodiment, entity 200 includes network interface 216 to interface entity 200 with a communications network 218. As shown in FIG. 2, baseband processor 212 and network interface 216 communicate with each other via a communication link 222. Network interface 216 is used to provide an outgoing signal 210 to transceiver portion 220 (optionally through baseband processor 212), which may be received from a remote server coupled to communications network 218. Baseband processor 212 optionally processes the data of outgoing signal 210 prior to being sent to transceiver portion 220. Transceiver 220 transmits the outgoing signal via antenna 202.

Entity 200 has an antenna assembly 202 that includes at least one antenna. The antenna is used to broadcast and receive signals that enable communication with other entities. Antenna(s) within antenna assembly 202 may be any type of antenna known to persons skilled in the relevant art(s), including a vertical, dipole, loop, Yagi-Uda, slot, or patch antenna type.

Transceiver 220 receives an analog received signal via antenna assembly 202. Transceiver 220 outputs a decoded data signal 214 generated from the analog received signal. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives outgoing signal 210, and is coupled to an input of RF front-end 204. Modulator/encoder 208 encodes outgoing signal 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the outgoing signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated received signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the received signal. For example, the received signal may include backscattered data formatted according to FM0 or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

Example embodiments of the present invention are described in further detail below. Such embodiments may be implemented in the environments and readers described above, and/or in alternative environments and alternative RFID devices.

### Example Embodiments

Methods, systems, and apparatuses for the identification of antennas used in full duplex communication systems are presented. In embodiments, an RFID tag is associated with an antenna in a communications system. The tag may be associated with the antenna in various ways. In example embodiments, the RFID tag is attached to a surface of an enclosure or encapsulating body for the antenna, a surface of the antenna, or is embedded within the antenna. The RFID tag may also be located a distance from the antenna. The RFID tag stores information that can be used to identify the antenna. These embodiments can be implemented in many types of communication entities, such as RFID readers, in addition to otherwise known communication entities in full duplex radio frequency (RF) systems.

The example embodiments described herein are provided for illustrative purposes, and are not limiting. The examples described herein may be adapted to any type of full duplex communication system. Further structural and operational embodiments, including modifications/alterations, will become apparent to persons skilled in the relevant art(s) from the teachings herein.

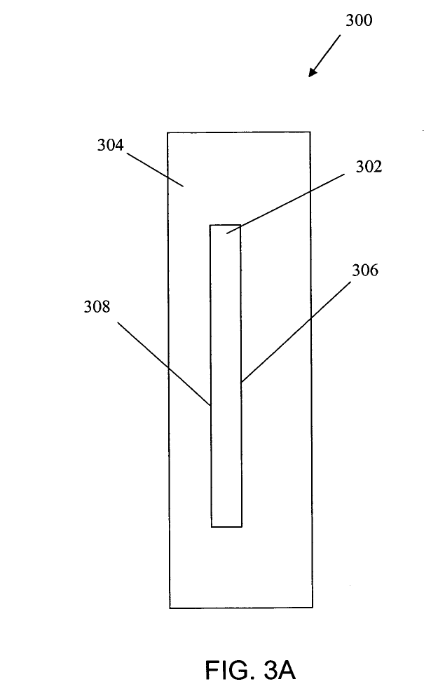

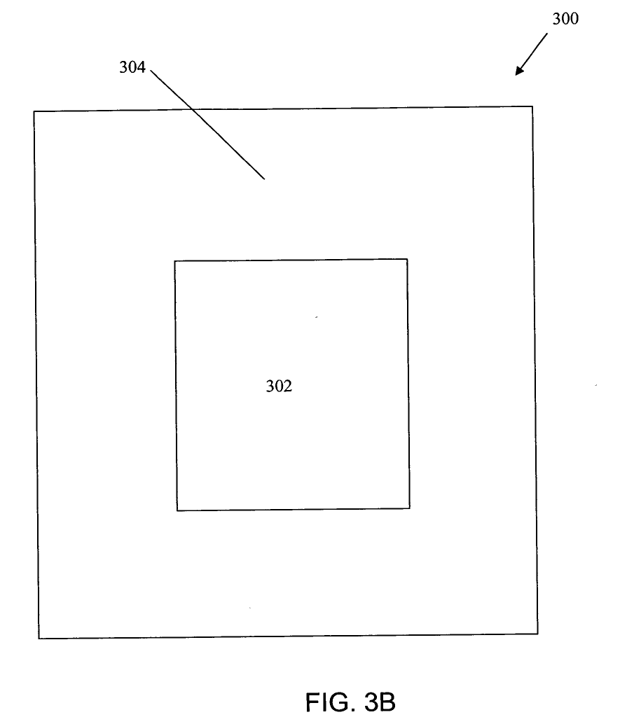

FIGS. 3A and 3B show side and front cross-sectional views, respectively, of an example conventional antenna assembly 300. Antenna assembly 300 includes antenna or radiating element (hereinafter referred to as an “antenna”) 302, and an encapsulating body 304 that encapsulates antenna 302. Antenna 302 is shown in FIGS. 3A and 3B as a patch-type antenna. Also shown in FIGS. 3A and 3B, antenna 302 is substantially planar, having opposing first and second planar surfaces 306 and 308. However, in alternative embodiments, antenna 302 may be a type of antenna other than a patch antenna, such as a dipole or monopole antenna, and may have shapes other than shown in FIGS. 3A and 3B.

Antenna 302 can be made of any suitable material, including a metal such as copper or aluminum. During operation, antenna 302 transmits RF signals.

As shown in FIGS. 3A and 3B, antenna 302 is positioned in encapsulating body 304. FIG. 3B shows encapsulating body 304 as being rectangular when viewed from a front view. In alternate embodiments, encapsulating body 304 may be configured in other shapes, such as to conform to an alternatively shaped antenna 302. In embodiments, encapsulating body 304 may have other shapes such as elliptical or irregular from side and/or front views.

In an embodiment, encapsulating body 304 is made of materials that are transparent to RF electromagnetic waves, such as plastics, polymers, etc. Encapsulating body 304 encapsulates antenna 302 to protect antenna 302 from environmental elements such as weather and/or impacts. In the example of FIGS. 3A and 3B, encapsulating body 304 fully encapsulates antenna 302 in a solid or gel-like mass. Alternatively, encapsulating body 304 may be an enclosure or housing that is open in a center portion. In a still further embodiment, encapsulating body 304 may be a radome such as are conventionally used to protect antennas.

A deficiency of antenna assembly 300 is that it is not easily identifiable. For example, if an antenna assembly 300 is coupled to a reader to operate as the reader antenna, there is no way to automatically configure the reader for use with antenna assembly 300, which may have characteristics different from those that the reader is setup for.

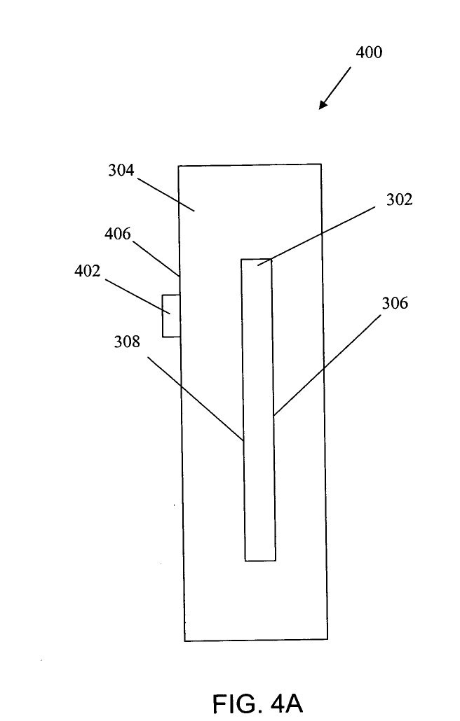

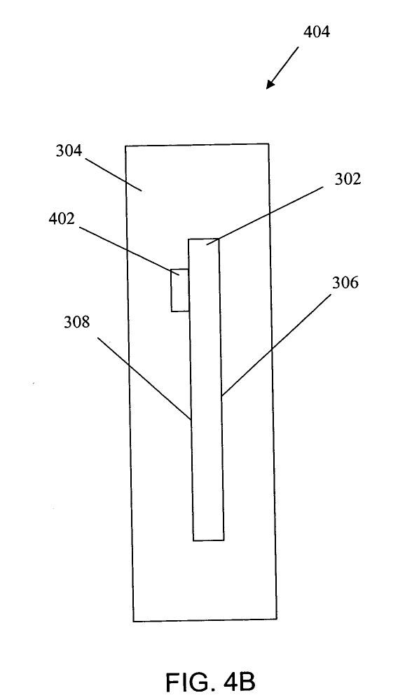

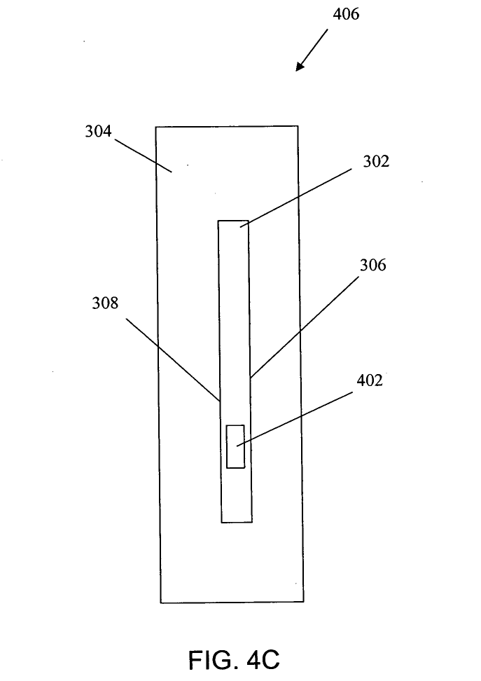

FIG. 4A shows a side cross-sectional view of an antenna assembly 400, according to an embodiment of the present invention. Antenna assembly 400 is similar to antenna assembly 300 shown in FIGS. 3A and 3B, with some differences described as follows. Antenna assembly 400 has an RFID tag 402 attached to a surface 406 of encapsulating body 304. FIG. 4A shows RFID tag 402 attached to a central region of surface 406 of encapsulating body 304. In embodiments, RFID tag 402 may be attached to any portion of surface 406. Furthermore, RFID tag 402 can be attached to surface 406 in a recessed or non-recessed manner. For example, in a recessed attachment embodiment, a cavity is formed in surface 406 and RFID tag 402 is placed within the cavity. In a still further embodiment, RFID tag may be completely encapsulated within encapsulating body 304 and not accessible from surface 406. In an embodiment where encapsulating body 304 is an enclosure or housing, RFID tag 402 may be attached anywhere on an inner or outer surface of the enclosure housing.

In embodiments, RFID tag 402 stores information that can be used to identify antenna assembly 400, and thus may be read to identify antenna 302.

FIG. 4B shows a side cross-sectional view of an antenna assembly 404, according to an embodiment of the present invention. In FIG. 4B, RFID tag 402 is attached to surface 308 of antenna 302. As shown in FIG. 4B, RFID tag 402 is completely encapsulated in encapsulating body 304, and thus is not accessible from surface 406. In a further embodiment, encapsulating body 304 may have a thickness such that RFID tag 402 attached to antenna 302 is partially exposed.

In FIG. 4B, RFID tag 402 is coupled to surface 308 of antenna 302 such that no portion of RFID tag 402 is within antenna 302. In alternate embodiments, RFID tag 402 may be placed in a cavity in antenna 302 such that a portion of RFID tag is embedded within antenna 302.

FIG. 4C shows a side cross-sectional view of an antenna assembly 406, according to another embodiment of the present invention. Antenna assembly 406 is substantially similar to antenna assembly 404 shown in FIG. 4B, except that RFID tag 402 is embedded within antenna 302 such that no portion of RFID tag 402 is accessible from any surface of antenna 302.

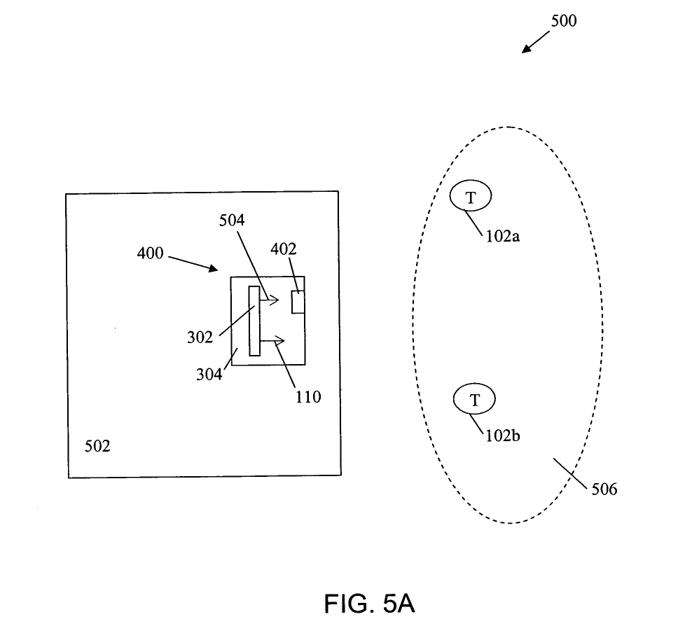

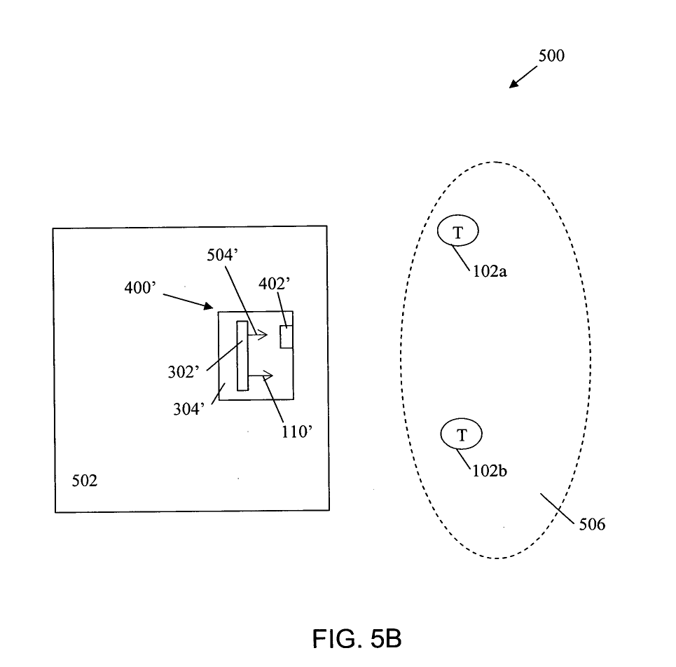

Embodiments of tags associated with antennas may be used in many applications. For example, FIG. 5A shows an RFID system 500, according to an example embodiment of the present invention. RFID system 500 includes a reader 502 and a population of RFID tags 506. Reader 502 includes antenna assembly 400, which includes antenna 302, encapsulating body 304, and RFID tag 402.

Population of RFID tags 506 includes tags 102a and 102b. In the example of FIG. 5A, all tags in population of tags 506 are in a communication range of reader 502.

According to an embodiment of the present invention, antenna 302 transmits at least two signals. A first interrogation signal 110 is used to communicate with tags 102 within population of tags 506. In an embodiment, first signal 110 is used to interrogate tags 102 within population of tags 506. A second signal 504 is used to communicate with RFID tag 402 associated with antenna assembly 400. In a first embodiment, first signal 110 and second signal 504 use different protocols such that first signal 110 does not cause a response from RFID tag 402 and second signal 504 does not cause a response from any tag within population of tags 506. In another embodiment, first and second signals 110 and 504 are transmitted according to a common protocol. Thus, in such an embodiment, tag 402 may respond to an interrogation performed by reader 502 during a same interrogation round used to interrogate tags 102a and 102b.

In an embodiment, RFID tag 402 is configured to have a lower sensitivity to signals broadcasted by antenna 302 when compared a sensitivity of tags 102 in population of tags 506. Since RFID tag 402 is in relatively close proximity to antenna 302 when compared to tags 102 in population of tags 502, RFID tag 402 receives more electromagnetic wave power than do tags 102 in population of tags 506. Thus, RFID tag 402 can be configured to be less sensitive to an electromagnetic wave broadcast from antenna 302, such as to protect RFID tag 402 from a level of power exceeding an acceptable range. Furthermore, a lower sensitivity may cause tag 402 to be less likely to respond to interrogations performed by readers in the local area other than reader 502. In embodiments, RFID 402 is made less sensitive by shortening an antenna of RFID tag 402, or by other isolation techniques as would be known to persons skilled in the relevant art(s).

In an embodiment, reader 502 is manufactured to be used with a particular antenna assembly 400, and has a plurality of settings, such as an output power level, based on one or more characteristics of antenna assembly 400, such as gain. Antenna assembly 400 may be configured to be removable. For example, antenna assembly 400 may be removed if it is damaged or if different antenna performance is desired.

For example, FIG. 5B shows RFID system 500 where reader 502 has antenna assembly 400 replaced with a second antenna assembly 400′. Second antenna assembly 400′ has an antenna 302′, an encapsulating body 304′, and an RFID tag 402′. Antenna 302′ may or may not be substantially similar to antenna 302 in FIG. 5A. For example, antenna assembly 400′ may have a different number of antennas than antenna assembly 400. Encapsulating body 304′ and RFID tag 402′ perform similar functions as encapsulating body 304 and RFID tag 402 as shown in FIG. 5A. Antenna 302′ also transmits at least two signals, a first signal 110′ and a second signal 504′. First signal 110′ is used to communicate with population of tags 506 and second signal 504′ is used to communicate with RFID tag 402′. In such an embodiment, when first antenna assembly 400 is replaced by second antenna assembly 400′, the plurality of setting of reader 502 that were configured with respect to first antenna assembly 400 may need to be changed to reflect characteristics of second antenna assembly 400′.

Settings of reader 502 may be changed by first identifying second antenna assembly 400′. In an embodiment, reader 502 identifies second antenna assembly 400′ by having antenna 302′ transmit second signal 504′ to interrogate tag 402′. Tag 402 may respond to the interrogation with identifying information, such as its identification number, to be identified by reader 502. The identifying information provided by tag 402 may be used to identify antenna assembly 400′, such as by looking up antenna assembly 400′ in a lookup table or database based on the identifying information. After identifying antenna assembly 400′, reader 502 may change one or more settings to optimize subsequent RF communications performed using second antenna assembly 400′. Such settings may include a transmit frequency, gain, polarization, input power, a number of input signals, an impedance, etc. In alternate embodiments, tag 402′ can respond to second signal 504′ with information indicating one or more characteristics of antenna 302′. Reader 502 can change one or more settings based on the received information.

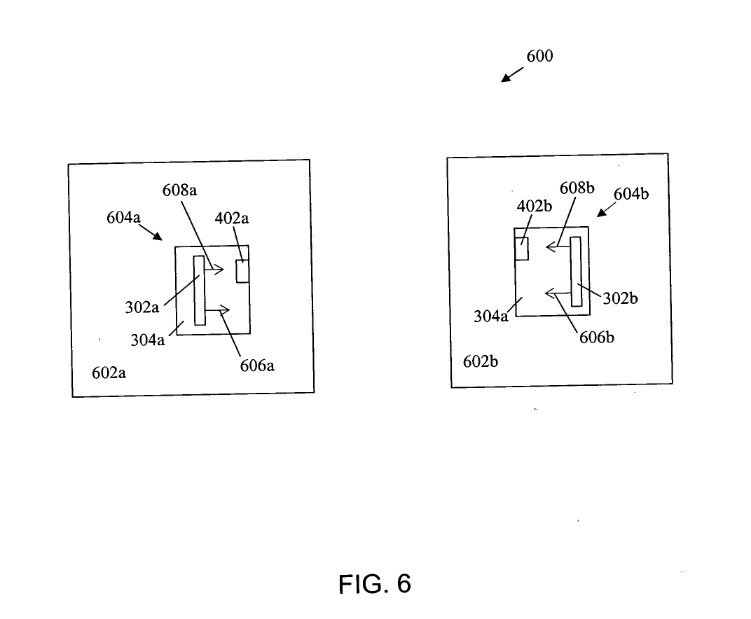

Embodiments of the present invention may be implemented in a variety of communication systems other than just an RFID communication system. For instance, FIG. 6 shows an example code division multiple access (CDMA) system 600, according to another embodiment of the present invention. CDMA system includes entities 602a and 602b. Although FIG. 6 shows CDMA system having two entities, in alternate embodiments there could be additional entities, as would be understood by person(s) skilled in the relevant art(s).

Entity 602a includes an antenna assembly 604a, which includes an antenna 302a, an encapsulating body 304a, and an RFID tag 402a. RFID tag 402a stores information that can be used to identify antenna 302a. Antenna 302a transmits at least a first signal 606a and a second signal 608a. Entity 602b includes an antenna assembly 604b which includes an antenna 302b, an encapsulating body 304b, and an RFID tag 402b. RFID tag 402b stores information that can be used to identify antenna 302b. Antenna 302b transmits at least a first signal 606b and a second signal 608b. Encapsulating bodies 304a and 304b serve similar purposes as encapsulating body 304 in FIG. 5A.

First signals 606a and 606b from entity 602a and entity 602b, respectively, are used to communicate with other entities within the CDMA system according to a CDMA protocol. Second signals 608a and 608b of entity 602a and entity 602b, respectively, are used to communicate with the RFID tags 402a and 402b, respectively. In embodiments, second signals 608a and 608b are used to interrogate RFID tags 402a and 402b, respectively, to identify antennas 302a and 302b. Once tags 402a and 402b are identified, the corresponding antenna assemblies 604a and 604b can be identified. Once the identities of antenna assemblies 604a and 604b are determined, one or more settings in entities 602a and 602b and/or other settings mentioned herein or otherwise known, such as output power level, can be adjusted based on the identification information and previously defined desired setting levels.

Although FIG. 6 shows a communication system that uses a CDMA protocol, other multiple access protocols such as TDMA or FDMA could also be used, as would be understood by someone skilled in the relevant art(s). In embodiments, entities 602a and 602b may be a variety of wireless devices such as cellular phones, personal digital assistants (PDA), etc.

Although the aforementioned embodiments have included a tag attached to an antenna assembly, the tag may be associated with the antenna assembly in other ways. In an embodiment, the tag is not attached to the antenna assembly. Rather, the tag is located a distance away from the antenna assembly and may be used to determine characteristics of the antenna assembly such as radiated power and/or to reference the antenna assembly.

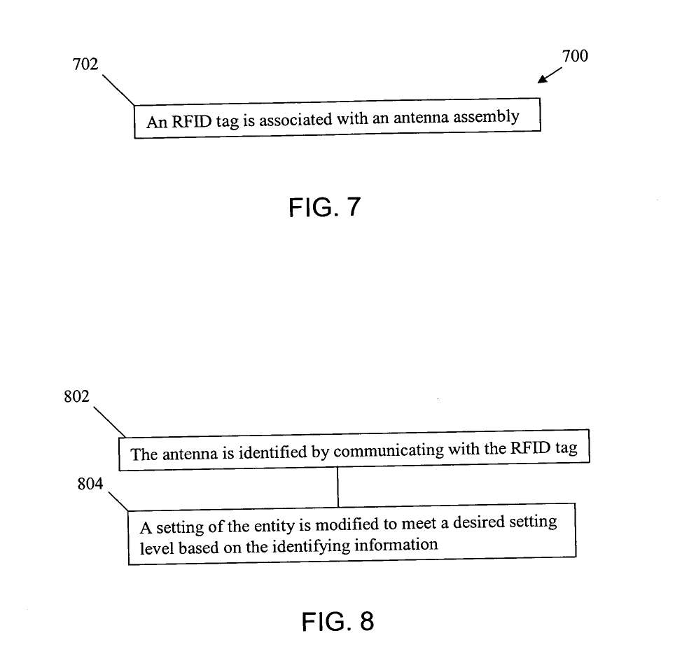

FIG. 7 shows a flowchart 700 for assembling a communication entity, according to an embodiment of the present invention. Flowchart 700 begins with step 702. In step 702, an RFID tag is associated with an antenna assembly of a communication entity. The antenna assembly includes an antenna and an encapsulating body. The RFID tag stores information configured to identify the antenna assembly. In embodiments, the RFID tag can be associated with the antenna assembly in a variety of ways, including being attached to a surface of an encapsulating body, a surface of an antenna, or embedded within the antenna. For example in antenna assemblies 400, 404, and 406, RFID tag 402 is placed on a surface of encapsulating body 304, a surface of antenna 302, or is embedded within antenna 302, respectively.

FIG. 8 shows optional additional steps 802 and 804 for flowchart 700 shown in FIG. 7. In step 802, the antenna of the communication entity is identified by communicating with an RFID tag associated with the antenna assembly to receive the identifying information from the tag. In embodiments, this communication is done by transmitting an RF signal that interrogates the RFID tag.

In step 804, a setting of the entity is modified to meet a desired setting level based on the identifying information or lack thereof. In further embodiments, the setting is level is adjusted to meet limits specified by a regulatory body such as the FCC. As described above, settings that can be adjusted include a transmit frequency, gain, polarization, input power, output power, a number of input signals, an impedance, etc.

For example, an output power level may be initially set during a manufacturing step. Reader 502 shown in FIG. 5A may be manufactured such that an antenna assembly is attached. Upon the initial attachment of antenna assembly 400, reader 502 may direct antenna 302 to transmit second signal 504 to interrogate RFID tag 402. Based on identification data received in the interrogation, the identity of RFID tag 402 is determined. From the identity of RFID tag 402, the identity of antenna assembly 400 may be determined. From previously determined characteristics of antenna assembly 400, such as gain, an output power level of first signal 110 may be adjusted to meet a desired level.

Moreover, output power levels of first output signals 606a and 606b of entities 602a and 602b in CDMA system 600 shown in FIG. 6 can also be adjusted in a similar manner as discussed above, as would be understood by persons skilled in the relevant art(s).

In an alternate embodiment, the output power level may be adjusted after a communication entity has been manufactured. In embodiments, communication entities are configured to have replaceable antenna assemblies. After replacing an antenna assembly, the output power level of the entity can be adjusted to meet a desired level. For example, as shown in FIGS. 5A and 5B, antenna assembly 400 in reader 502 may be replaced with antenna assembly 400′. Once antenna assembly 400′ is installed, reader 502 may instruct antenna 302′ to transmit second signal 504′ to interrogate RFID tag 402′. Based on identification data received in the interrogation, the identity of RFID tag 402′ is determined. From the identity of RFID tag 402′, the identity of antenna assembly 400 may be determined. Previously determined characteristics of antenna assembly 400′, such as gain, an output power level of first signal 110 may be adjusted to meet a desired level.

Moreover, output power levels of first output signals 606a and 606b of entities 602a and 602b in CDMA system 600 shown in FIG. 6 can also be adjusted in a similar manner if antenna assemblies 604a and 604b were to be replaced, as would be understood by persons skilled in the relevant art(s).

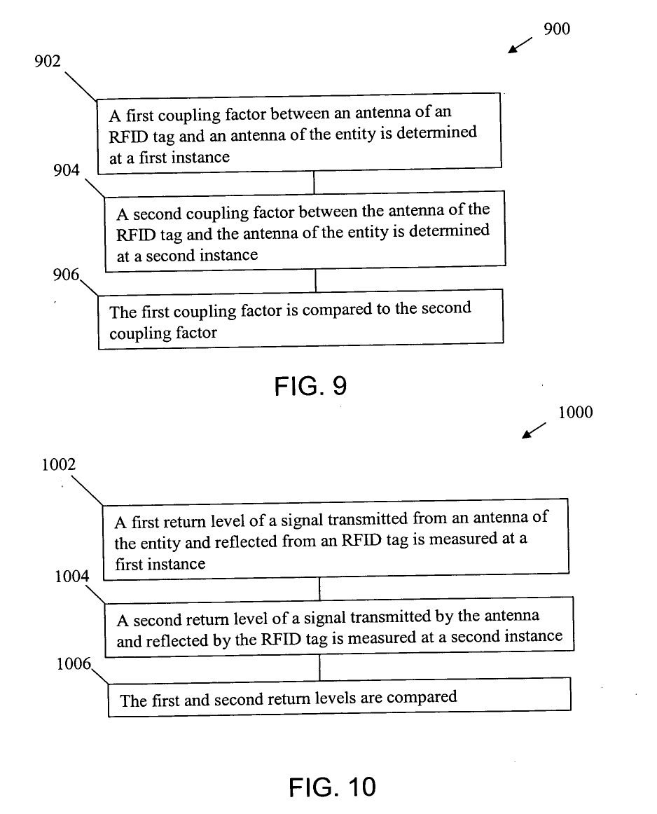

Embodiments of the present invention may also be used to monitor performance of communications entities. For instance, flowchart 900 shown in FIG. 9 shows example steps to determine a performance of a communication entity, according to an embodiment of the present invention. Flowchart 900 begins in step 902. In step 902, a first coupling factor between an antenna of an RFID tag and an antenna of the entity is determined at a first instance. The antenna is located within an antenna assembly. The RFID tag is associated with the antenna assembly. In an embodiment, the first coupling factor is determined during a post-assembly test of the antenna of the communication entity. For example, a first coupling factor between antenna 302 of reader 502 in RFID system 500 shown in FIG. 5A may be determined at a first instance. A coupling factor, i.e., a ratio between an amount of input power that reaches an output port and the total input power, can be defined for many different types of systems such as coupled microstrip lines, microwave components, etc. With respect to reader 502, a coupling factor may be defined as the fraction of power input to antenna 302 received by RFID tag 402 and then reflected (backscattered) to the receiver.

In step 904, a second coupling factor between the antenna of the RFID tag and the antenna of the entity is determined at a second instance. In an embodiment, the second coupling factor is determined after a first use of the entity. For example, the second coupling factor can be determined between antenna 302 and RFID tag 402. The second coupling factor may be determined while reader 502 is communicating with population of tags 506. In embodiments, reader 502 may measure a coupling factor one or more times.

In step 906, the first and second coupling factors are compared. In embodiments, the first and second coupling factors can be compared by a computer or other logic device. For example, reader 502 may be used to compare the first and second coupling factors. In an embodiment where a coupling factor is continually measured, coupling factors may be compared after every measurement and/or after a number of measurements.

In embodiments, a difference between the first and second coupling factors indicates a performance issue, such as antenna degradation or reflections from outside sources e.g. due to ice forming in a near field of antenna 302. If a performance issue is detected, a variety of possible steps can be taken such as reorienting antenna assembly 400 to avoid potential obstacles and/or designating reader 502 as requiring repair or maintenance.

FIG. 10 shows an example flowchart 1000 that can be used to determine a performance of a communication entity, according to an embodiment of the present invention. Flowchart 1000 begins in step 1002. In step, 1002, a first return level of a signal transmitted from an antenna of the entity and reflected from an RFID tag is measured at a first instance. The antenna is located within an antenna assembly. The RFID tag is associated with the antenna assembly. In an embodiment, the first return level is measured during a post-assembly test of the antenna of the communication entity. For example, a first return level of a signal transmitted by antenna and reflected from RFID tag 402 is measured at a first instance.

In step 1004, a second return level of a signal transmitted by the antenna and reflected by the RFID tag is measured at a second instance. In an embodiment, the second return level is measured after a first use of the entity. For example, the second return level of a signal transmitted by antenna 302 and reflected from RFID tag 402 may be measured while reader 502 is in use. In an embodiment, a return level is measured one or more times while reader 502 is in use.

In step 1006, the first and second return levels measured are compared. For example, the first and second return levels measured between antenna 302 and RFID tag 402 of reader 502 in RFID system 500 are compared, shown in FIG. 5A. A difference between the first and second return levels measured may indicate a performance issue such as degradation in a transmission line used to feed antenna 302. In an embodiment, where a return value is measured repeatedly, a return value measured most recently may be compared to the first return value measured and/or return values measured at different instances during operation.

Although the example steps of flowcharts 900 and 1000 were illustrated using RFID system 500 shown in FIG. 5, the example steps of flowcharts 900 and 1000 may also be applied to CDMA system 600 shown in FIG. 6 or any other communication system using an antenna assembly in accordance with an embodiment of the present invention, as would be understood by persons skilled in the relevant art(s).

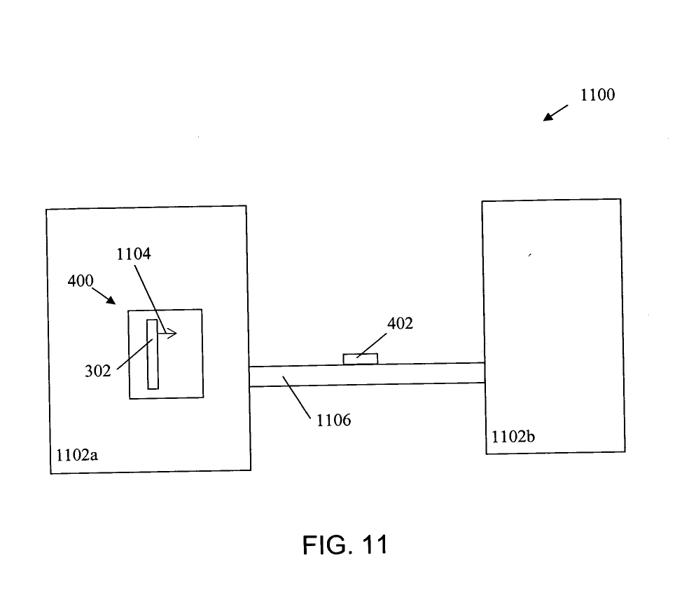

Embodiments of the present invention can be used in further applications. For example, FIG. 11 shows another example communication system 1100 according to an embodiment of the present invention. Communication system 1100 includes communication entities 1102a and 1102b coupled to each other using a transmission line 1106. Transmission line 1106 can be any type of transmission line such as a coaxial line, a fiber optic line, or a twisted pair line. RFID tag 402 is attached to transmission line 1106. Entity 1102a includes antenna assembly 400. Antenna 302 within antenna assembly 400 broadcasts at least one signal 1104. Signal 1104 is used to communicate with RFID tag 402. In embodiments, signal 1104 is used to identify tag 402 in order to identify transmission line 1106. In further embodiments, identification data is used by entity 1106 to adjust an output power level based on loss information that is known about transmission line 1106.

For example, upon coupling entity 1102a to entity 1102b using transmission line 1106, antenna 302 transmits signal 1104 to interrogate tag 402. Tag 402 sends a response to antenna 302 including an identity of tag 402. Entity 1102a uses the identity of tag 402 to determine an identity of transmission line 1106. Based on known characteristics, such as loss and/or length, of transmission line 1106, stored in entity 1102a or elsewhere, entity 1102a adjusts one or more settings such as an input power and/or an output impedance to ensure entity 1102b receives a signal transmitted by entity 1102a through transmission line 1106.

### Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system using a removable storage drive, hard drive, or communications interface. The control logic (software), when executed by a processor, causes the processor to perform the functions of the invention as described herein.

According to an example embodiment, a reader may execute computer-readable instructions to transmit a RF signal, and to process tag responses, including comparing tag responses, as further described elsewhere herein.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. An entity in a full-duplex radio frequency (RF) system comprising:
an antenna assembly, including at least an antenna and an encapsulating body, wherein the encapsulating body encapsulates the antenna; and
a radio frequency identification (RFID) tag, wherein the tag is associated with the antenna assembly, wherein the tag stores information useable to identify the antenna.

2. The entity of claim 1, wherein the RFID tag is attached to a surface of the encapsulating body.

3. The entity of claim 1, wherein the RFID tag is attached to a surface of the antenna.

4. The entity of claim 1, wherein the RFID tag is embedded within the antenna.

5. The entity of claim 1, wherein the RFID tag stores information regarding at least one property of the antenna.

6. The entity of claim 1, wherein the antenna is a dipole antenna, a dual dipole antenna, or a patch antenna.

7. The entity of claim 1, wherein the RFID tag is configured to be less sensitive to an RF signal transmitted by the antenna relative to a second RFID tag in a communication range of the entity, wherein the second RFID tag is not associated with the antenna assembly.

8. The entity of claim 7, wherein the first RFID tag is configured to be less sensitive by shortening an antenna of the RFID tag.

9. The entity of claim 1, wherein the full-duplex RF system is an RFID system.

10. The entity of claim 1, wherein the full-duplex RF system is a Code Division Multiple Access (CDMA) system, a Time Division Multiple Access (TDMA) system, or a Frequency Division Multiple Access (FDMA) system.

11. The entity of claim 1, wherein the entity is an RFID reader.

12. The entity of claim 1, wherein the encapsulating body is a substantially hollow enclosure.

13. The entity of claim 1, wherein the RFID tag is configured to operate with a different communication protocol than that of a second RFID tag in a communication range of the entity, wherein the second RFID tag is not associated with the antenna assembly.

14. The method of claim 1, wherein the RFID tag is located a substantially fixed distance from the antenna.

15. A transmission medium, comprising:
a transmission line; and
an RFID tag attached to the transmission line, wherein the tag stores information configured to identify the transmission medium.

16. The transmission medium of claim 15 wherein the transmission line is a coaxial line.

17. The transmission medium of claim 15 wherein the transmission line is fiber optic line.

18. A method of assembling an entity in a full duplex RF system, comprising:
associating an RFID tag with an antenna assembly, wherein the antenna assembly includes an antenna and an encapsulating body, wherein the RFID tag stores information configured to identify the antenna assembly.

19. The method of claim 18, further comprising:
identifying the antenna assembly by communicating with the RFID tag to receive the identifying information from the tag.

20. The method of claim 19, further comprising:
modifying a setting of the entity to meet a desired setting level based on the identifying information.

21. The method of claim 19, wherein the modifying step comprises:
modifying an input power level to meet a desired output power level based on the identifying information.

22. The method of claim 19, wherein the modifying step comprises:
modifying an output impedance to meet a desired output power level based on the identifying information.

23. The method of claim 19, wherein the modifying step comprises:
modifying an input frequency based on the identifying information.

24. The method of claim 19, further comprising:
determining a characteristic of the antenna assembly by communicating with the RFID tag.

25. The method of claim 24, further comprising:
determining a gain of the antenna assembly by communicating with the RFID tag.

26. The method of claim 18, further comprising:
replacing the first antenna assembly with a second antenna assembly having a second RFID tag associated therewith;
identifying the second antenna assembly by communicating with the second RFID tag; and
modifying a setting of the entity to meet a desired setting level based on identifying information received from the second RFID tag.

27. The method of claim 18, wherein the attaching comprises:
attaching the RFID tag to a surface of the encapsulating body.

28. The method of claim 18, wherein the attaching step comprises:
attaching the RFID tag to a surface of the antenna.

29. The method of claim 18, wherein the attaching step comprises:
embedding the RFID tag within the antenna.

30. The method of claim 18, wherein the encapsulating body defines a substantially hollow enclosure, wherein the attaching step comprises:
attaching the RFID tag to an inside surface of the encapsulation body.

31. A method of determining a performance of a communication entity in a full-duplex RF system comprising:
determining a first coupling factor between an antenna of an RFID tag and an antenna of the entity at a first instance, wherein the antenna is located within an antenna assembly, wherein the RFID tag is associated with the antenna assembly;
determining a second coupling factor between the antenna of the RFID tag and the antenna of the entity at a second instance; and
comparing the first coupling factor to the second coupling factor.

32. The method of claim 31, wherein determining the first coupling factor further comprises:
determining the first coupling factor during a post-assembly test of the antenna of the entity.

33. The method of claim 31, wherein determining the second coupling factor further comprises:
determining the second coupling factor after a first use of the entity.

34. The method of claim 33, wherein the RFID tag is located a substantially fixed distance from the antenna.

35. A method of determining a performance of a communication entity in a full-duplex RF system comprising:
measuring a first return level of a signal transmitted from an antenna of the entity and reflected from an RFID tag at a first instance, wherein the antenna is located within an antenna assembly, wherein the RFID tag is associated with the antenna assembly;
measuring a second return level of a signal transmitted by the antenna and reflected by the RFID tag at a second instance; and
comparing the first and second return levels.

36. The method of claim 35, wherein determining the first return level further comprises:
measuring the first return level during a post-assembly test of the antenna of the entity.

37. The method of claim 35, wherein measuring the second return level further comprises:
measuring the second return level after a first use of the entity.

38. The method of claim 35, wherein the RFID tag is located a substantially fixed distance from the antenna.

39. A method of assembling a communication system comprising:
coupling a first communication entity to a second communication entity with a transmission medium; and
associating an RFID tag with the transmission medium, wherein the RFID tag stores information configured to identify the transmission medium.

40. The method of claim 39, further comprising:
identifying the transmission medium by communicating with the REID tag; and
modifying a setting of the first entity and/or second entity based on the identity of the RFID tag.

41. The method of claim 40, wherein the modifying step comprises:
adjusting an output power level, an input impedance of the first entity and/or the second entity, or an output impedance of the first entity and/or the second entity.

42. A system for assembling an entity in a full duplex RF system, comprising:
means for associating an RFID tag to an antenna assembly; and
means for storing in the RFID tag identifying information for the antenna assembly.

43. The system of claim 42, further comprising:
means for determining the identifying information of the antenna assembly by communicating with the RFID tag.

44. The system of claim 43, further comprising:
means for modifying a setting of the entity based on the identifying information.
